(19) United States
(12) Patent Application Publication
(10) Pub. No.: US 2024/0213812 A1
(43) Pub. Date: Jun. 27, 2024

(54) WIRELESS CHARGING AND POWERING OF TOOLS

(71) Applicant: Snap-on Incorporated, Kenosha, WI (US)

(72) Inventors: Ottoleo Kuter-Arnebeck, Kenosha, WI (US); Nicholas Gabbey, Kenosha, WI (US); Jonathan I. Andersen, Kenosha, WI (US)

(73) Assignee: Snap-on Incorporated, Kenosha, WI (US)

(21) Appl. No.: 18/086,535

(22) Filed: Dec. 21, 2022

(51) Int. Cl. H02J 50/40; B25F 5/02; H02J 50/00; H02J 50/10; H02M 7/00

(52) U.S. Cl. CPC H02J 50/402; B25F 5/02; H02J 50/005; H02J 50/10; H02M 7/003

(57) ABSTRACT

The present invention relates to wirelessly transferring energy to a cordless power tool to charge a power source, such as a rechargeable battery pack, coupled to the tool, and/or to provide power directly to the tool for operation of the tool. For example, a transmitter transmits a magnetic field, and a receiver receives energy via the magnetic field. When a tool and/or battery pack with the receiver is within the magnetic field, a sensing circuit connected to the receiver recognizes the magnetic field and signals a control circuit to capture energy, via the magnetic field. The energy received by the receiver can then be converted into an electrical current that can be used to supply power to the tool and/or battery pack.

### TECHNICAL FIELD

The present invention relates generally to wireless charging and powering for power tools. More particularly, the present invention relates generally to the use of magnetic fields to wirelessly charge and/or supply power to tools.

### BACKGROUND

Cordless power tools, such as drills, impact drivers, power ratchets, flashlights, etc., are typically powered by rechargeable battery packs. These battery packs are generally charged by connecting the battery packs to corded chargers that connect to an external power source, such as a wall outlet or generator. While rechargeable battery packs provide the convenience of powering tools, the battery packs can only provide power for a limited amount of time before being depleted and needing to be recharged. The charging process to restore the battery pack to full power can be time consuming. Thus, when the battery pack is depleted, the battery pack must be removed from the tool to charge the battery pack, causing a disruption in work flow.

To address this issue, some tools have tried to implement inductive wireless charging methods for charging battery packs. However, inductive charging requires a receiver coil that must be concentrically aligned with an emitting coil. If the two coils are not properly concentrically aligned, the efficiency of power transfer is significantly reduced. Thus, the inductive charging method defeats the purpose of a “cordless” method of transferring power, as it requires precise placement of the battery pack above the coil.

### SUMMARY

In an embodiment, the present invention relates broadly to wirelessly transferring energy to a cordless power tool to charge a power source, such as a rechargeable battery pack, coupled to the tool, and/or to provide power directly to the tool for operation of the tool. For example, one or more wireless receivers may be implemented within or on a housing of the tool. The receiver(s) are adapted to receive energy from an electromagnetic or magnetic field. The energy received by the receiver(s) is converted, via power electronics, into an electrical current that can be used to supply power to a battery pack coupled to the tool and/or directly to a motor and/or other electrical components of the tool. The receivers can be different shapes and sizes, and placed on or in multiple planes of the tool. For example, the receiver(s) can be implemented in or on a handle, base or drive body of the tool, and can be internal or external to the housing of the tool.

In another example, an adapter that includes one or more wireless receivers can be coupled to the tool between the tool and the power source (i.e., rechargeable battery pack). The receiver(s) are adapted to receive energy from an electromagnetic or magnetic field, can be different shapes and sizes, and placed on or in multiple planes of the adapter. The energy received by the receiver(s) is converted, via power electronics internal or external to the adapter, into an electrical current that can be used to supply power to a battery pack coupled to the adapter and/or directly to a motor and/or other electrical components of the tool. Such an adapter can be used with current tools and battery packs to allow for wireless transfer of energy.

In another embodiment, the present invention relates broadly to a structure that emits a magnetic field or an electromagnetic wave or field to one or more receivers, which convert the magnetic field or an electromagnetic wave or field to electrical current. In an example, the structure can include a quasi-enclosure that directs the emitted magnetic field or an electromagnetic wave or field. For example, the structure may include a powered transmitter with coils for producing a magnetic field to wirelessly charge tools. When a tool, adapter, and/or battery pack with a receiver is placed in or near the structure, the magnetic field or an electromagnetic wave or field received by the receiver is converted, via power electronics internal or external to the tool, adapter, and/or battery pack, into an electrical current that can be used to supply power to the tool, adapter, and/or battery pack.

In another embodiment, the present invention relates broadly to a wireless system that wirelessly provides power using resonant wireless power transfer. The wireless system includes one or more transmitting structures capable of providing energy to multiple receiving structures, such as receivers of a tool, battery/battery pack, and/or adapter. The transmitting structure(s) and receiving structure(s) operate at matching resonant frequencies, determined by distributed capacitance, resistance, and inductance of the coils of the transmitting structure(s) and receiving structure(s) by tunneling energy from a transmitter (such as a transmitter coil) of the transmitting structure, to a receiver (such as a receiver coil) of the receiving structure. In an example, a transmitting structure may transmit a magnetic field in a frequency of about 6.78 MHz or about 13.56 MHz, and is disposed in a desired location. When a tool and/or battery/battery pack with the receiver is within the magnetic field of the transmitting structure, a sensing circuit connected to the receiver and configured to recognize the magnetic field at the broadcast frequency, for example about 6.78 MHz or about 13.56 MHz, and then signals a control circuit to capture energy, via the magnetic field. The energy received by the receiver can then be converted into an electrical current that can be used to supply power to the tool and/or battery pack.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a component diagram of an exemplar tool with a receiver, according to an embodiment of the present invention.

FIG. 2 is a side view of an exemplar tool with multiple receivers, according to an embodiment of the present invention.

FIG. 3 is a top view of an exemplar tool with multiple receivers, according to an embodiment of the present invention.

FIG. 4 is a rear view of an exemplar tool with multiple receivers, according to an embodiment of the present invention.

FIG. 5 is a component diagram of an exemplar tool coupled to an adapter with a receiver, according to an embodiment of the present invention.

FIG. 6 is a side view of the adapter decoupled from an exemplar tool, according to an embodiment of the present invention.

FIG. 7 is a front view of the adapter decoupled from an exemplar tool, according to an embodiment of the present invention.

FIG. 8 is a component diagram of a structure adapted to emit a magnetic field, according to an embodiment of the present invention.

FIG. 9 is a perspective view of the structure adapted to emit the magnetic field of FIG. 8, according to an embodiment of the present invention.

FIG. 10 is a component diagram of a transmitter and receiver for wireless transferring energy, according to an embodiment of the present invention.

FIG. 11 is a diagram of a transmitter and an exemplar tool with a receiver for wireless transferring energy, according to an embodiment of the present invention.

### DETAILED DESCRIPTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

In an embodiment, the present invention relates broadly to wirelessly transferring energy, such as magnetic field or an electromagnetic wave or field, to a cordless power tool that is configured to convert such energy to electrical current, to charge a power source, such as a rechargeable battery pack, coupled to the tool, and/or to provide power directly to the tool for operation of the tool. For example, one or more wireless receivers may be implemented within or on a housing of a tool. The receiver(s) are adapted to receive energy in the form of an electromagnetic or magnetic field. The energy received by the receiver(s) is converted, via power electronics, into an electrical current that can be used to supply power to a battery pack coupled to the tool and/or directly to a motor and/or other electrical components of the tool. The receivers can be different shapes and sizes, and placed on or in multiple planes of the tool. For example, the receiver(s) can be implemented in or on a handle, base, or drive body of the tool, and can be internal and/or external to the housing of the tool.

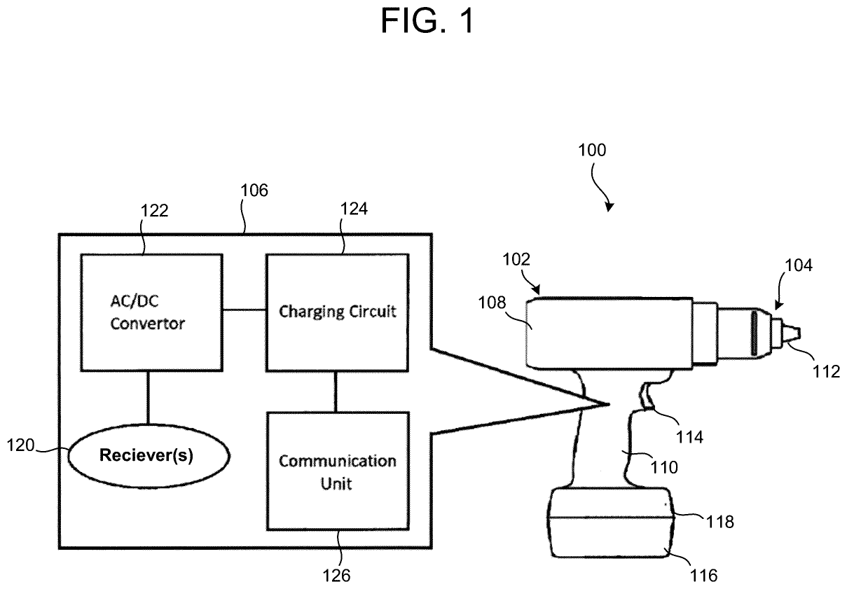

Referring to FIG. 1, wireless charging may be implemented in an exemplar tool 100, such as a cordless drill-type tool. The tool 100 may include a tool housing 102 and output assembly 104 (such as a drill chuck), and electronic components 106 (including a receiver, as described in further detail below). The tool housing 102 may include first and second housing portions that are coupled together in a clamshell type manner and securely coupled to the output assembly 104. The tool housing 102 may also include motor and handle housing portions 108, 110. In an embodiment, the handle housing portion 110 extends substantially perpendicular to the motor housing portion 108. In other embodiments, the handle housing portion 110 may be disposed at a non-perpendicular angle relative to the motor housing portion 108. The tool housing 102 may enclose or house an electric motor, such as a brushless DC (BLDC) motor, controller, a switch assembly, display with buttons for configuring and setting the tool, one or more indicators such as light emitting diodes, and other components for operation of the tool, for example.

The output assembly 104 includes a drill chuck 112 that is adapted to receive and hold a tool bit and apply torque to a work piece, such as a fastener. A rotational direction of the output assembly 104 can be selected via a selector switch to be either a first or second rotational direction (such as, clockwise or counterclockwise). The tool 100 also includes a trigger 114 that can be actuated by a user to cause the tool 100 to operate. As illustrated, the trigger 114 is disposed proximal to an intersection of the handle and motor housing portions 110, 108. The user can depress the trigger 114 inwardly to selectively cause power to be drawn from a power source 116 and cause the motor to provide torque to the output assembly 104 and cause the drill chuck 112 to rotate in a desired rotational direction. The trigger 114 may also be operably coupled to a switch mechanism that is adapted to cause power to be supplied from the power source 116 to the motor when the trigger 114 is actuated.

Any suitable trigger 114 or switch can be implemented without departing from the spirit and scope of the present invention. For example, the trigger 114 may also be biased such that the trigger 114 is inwardly depressible, relative to the tool 100, to cause the tool 100 to operate, and a release of the trigger 114 causes the trigger 114 to move outwardly, relative to the tool 100, to cease operation of the tool 100 via the biased nature of the trigger 114. The trigger 114 and switch mechanism may also be a variable speed type mechanism. In this regard, actuation or depression of the trigger 114 causes the motor to operate at a faster speed the further the trigger 114 is depressed.

The motor may be a BLDC or brushed type motor, or any other suitable motor. A power source 116 can be associated with the tool 100 to provide electric power to the tool 100. In an embodiment, the power source 116 can be housed via a battery attachment portion 118 at an end of the tool housing 102, such as an end of the handle housing portion 110. The power source 116 may also be an external component that is not housed by the tool 100, but is operatively coupled to the tool 100 through, for example, wired or wireless means. In an embodiment, the power source 116 is a removable and rechargeable battery pack that is adapted to be disposed in and coupled to the battery attachment portion 118 of the tool housing 102 and electrically coupled to corresponding terminals of the tool 100.

The electronic components 106 may be disposed on or in any portion of the tool housing 102, and electrically coupled to the power source 116 and/or components housed in the tool housing 102, such as the electric motor, controller, switch assembly, display with buttons for configuring and setting the tool, one or more indicators such as light emitting diodes, and other components for operation of the tool. The electronic components 106 are adapted to receive energy from an electromagnetic or magnetic field. The energy received is converted into electrical current that can be used to supply power to the power source 116 coupled to the tool 100, to charge the power source 116, and/or directly to the motor and/or other electrical components of the tool 100 to directly operate the motor and/or other electrical components.

In an embodiment, the electronic components 106 may include one or more receivers 120, an AC/DC converter 122, a charging circuit 124, and a communication unit 126. The receiver(s) 120 can be, for example, a coil of wire or other conductive material which, when placed in a magnetic field where the field lines pass through a plane or planes formed by the coil, induce an electric current in the coil in a well-known manner. The receiver(s) 120 can alternatively be an antennae adapted to capture electromagnetic energy in a radio frequency or microwave frequency spectrum. In another embodiment, the receiver(s) 120 can be both a coil shaped and sized to interact with a magnetic field and an antennae to interact with an electromagnetic signal.

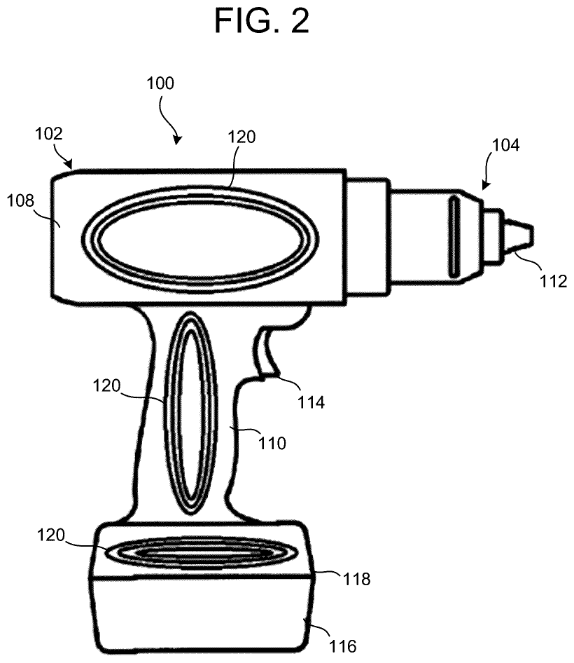

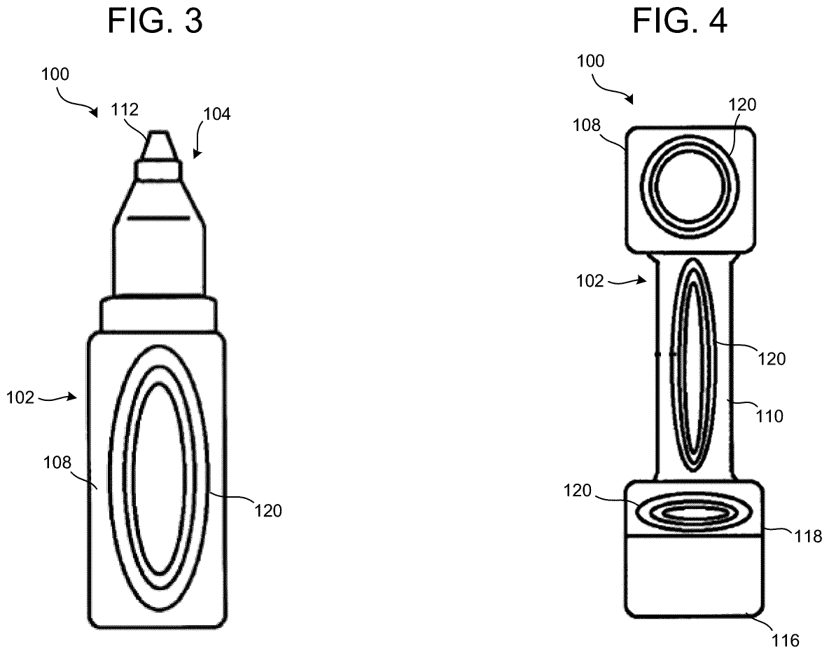

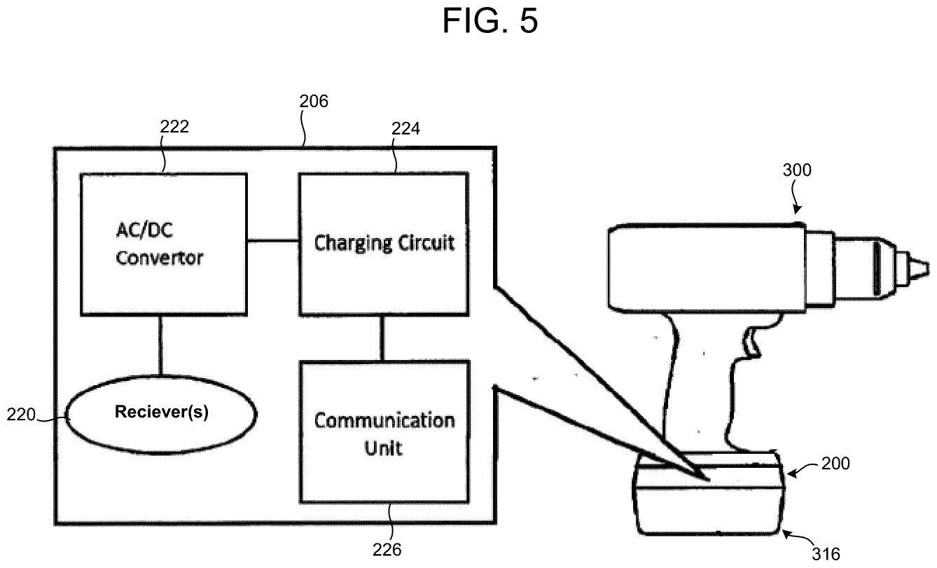

Referring to FIGS. 2-4, the receiver(s) 120 can be different shapes and/or sizes, and placed on or in multiple planes of the tool housing 102. For example, the receiver(s) 120 can be implemented in or on the motor housing portion 108, handle housing portion 110, and/or battery attachment portion 118 of the tool housing 102, and can be internal or external to the tool housing 102. Placing the receivers 120 in or on various portions of the tool housing 102 in various orientations allows for one or more of the receivers 120 to receive energy from an electromagnetic or magnetic field without requiring the tool 100 to be placed in a specific orientation relative to the electromagnetic or magnetic field.

Referring back to FIG. 1, each of the receiver(s) 120 may be electrically coupled to an AC/DC converter 122. The energy received or generated by the receiver(s) 120 may be output to the AC/DC converter 122, which converts the energy into an electrical current that can be used to supply power to the power source 116 coupled to the tool 100 and/or directly to a motor and/or other electrical components of the tool 100.

For example, the AC/DC converter 122 may be directly coupled to the motor and/or other electrical components of the tool 100 and supply voltage directly to the motor and/or other electrical components of the tool 100. The AC/DC converter 122 may be coupled to the charging circuit 124, and the charging circuit 124 may be operably coupled to the power source 116 (such as a rechargeable battery pack) via the terminals of the tool 100. Thus, the AC/DC converter 122 can supply voltage to the power source 116 to charge the power source 116. Instead of a direct coupling, the AC/DC converter 122 may be operably coupled to the power source 116, motor and/or other electrical components of the tool 100 via one or more batteries and/or capacitors. The batteries and/or capacitors may be used to store electric voltage until the stored voltage can be used by the tool 100 and/or power source 116.

The communication unit 126 may be adapted to communicate with a transmitter that provides an electromagnetic or magnetic field, and/or other components of the tool 100 and/or power source 116. The communication unit 126 can be used to identify the tool 100 with the transmitter, type of power source 116, state of charge of the power source 116, and other information useful in optimizing the wireless transfer of energy. For example, if the communication unit 126 informs the transmitter that the power source 116 is substantially full, then the transmitter does not provide any electromagnetic or magnetic field, since charging is unnecessary. Likewise, if the communication unit 126 informs the transmitter that the power source is substantially depleted, the transmitter may create an enhanced electromagnetic or magnetic field to speed charging, and then reduce the electromagnetic or magnetic field once charging is almost complete. It will be appreciated that such communication between the tool 100 and transmitter can be used to create a “smart system,” which is adaptable and modifiable based on, for example, the type of tool, state of charge, and/or type of power source.

Electronic components similar to the electronic components 106 may alternatively or additionally be placed in or on a housing of the power source 116 to allow for independent wireless charging of the power source 116. Further, while the tool is described as a cordless drill type tool, the electronic components 106 (including receiver(s) 120) can be implemented in any type of power tool, including but not limited to, drills, cordless ratchets, cordless torque tools, impact drivers, grinders, saws, hammer drills, flashlights, etc.

In another example, an adapter that includes one or more wireless receivers can be coupled to a tool between the tool and the power source (i.e., rechargeable battery pack). The receiver(s) are adapted to receive energy from an electromagnetic or magnetic field, can be different shapes and/or sizes, and placed on or in multiple planes of the adapter. The energy received by the receiver(s) is converted, via power electronics internal or external to the adapter, into an electrical current that can be used to supply power to a battery pack coupled to the adapter and/or directly to a motor and/or other electrical components of the tool. Such an adapter can be used with current tools and battery packs to allow for wireless transfer of energy. It will be appreciated that such adapter can be used to adapt existing power tools that do not include receivers to be used with the present invention, without requiring substantial or any modification of such existing power tools.

Referring to FIGS. 5-7, an adapter 200 may be coupled to an exemplar tool 300, such as, for example, a cordless drill type tool similar to the tool 100, and to a power source 316, such as a rechargeable battery pack. The tool 300 is essentially the same as the tool 100 described above, except that the receiver(s) 120 may be omitted from the tool 300. The power source 316 may be essentially the same as the power source 116 described above. In this embodiment, electronic components 206 may be disposed in the adapter 200. Similar to the electronic components 106 described above, the electronic components 206 may include one or more receivers 220, an AC/DC converter 222, a charging circuit 224, and a communication unit 226. The receiver(s) 220 can be a coil of wire or other conductive material which, when placed in a magnetic field where the field lines pass through a plane or planes formed by the coil, induce an electric current in the coil in a well-known manner. The receiver(s) 220 can alternatively be an antennae adapted to capture electromagnetic energy in a radio frequency or microwave frequency spectrum. In another embodiment, the receiver(s) 220 can be both a coil shaped and sized to interact with a magnetic field and an antennae to interact with an electromagnetic signal.

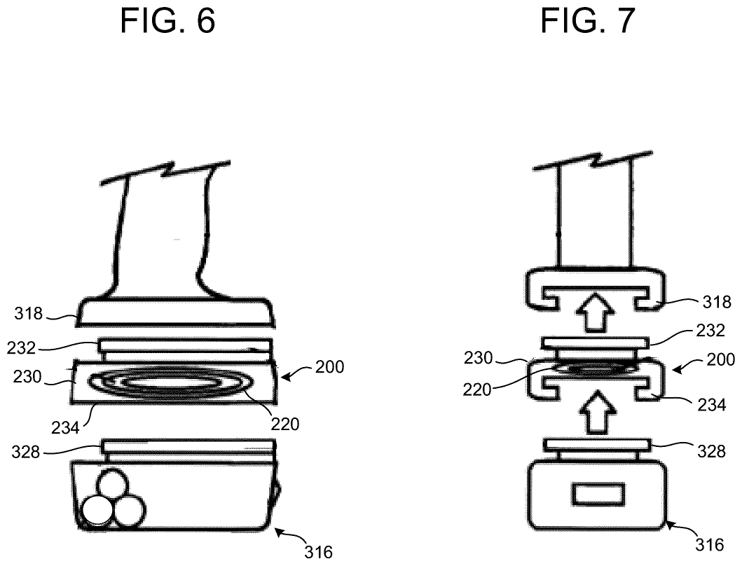

Referring to FIGS. 6 and 7, the adapter 200 includes an adapter housing 230 that houses the electronic components of the adapter 200, such as the electronic components 206. A first side or top side of the adapter housing 230 may include a tool attachment portion 232, and a second side or bottom side of the adapter housing 230 may include a battery attachment portion 234. The tool attachment portion 232 is shaped to couple to a battery attachment portion 318 of the tool 300 and electrically coupled to corresponding terminals of the tool 300. Similarly, the battery attachment portion 232 of the adapter 200 is shaped to couple to an attachment portion 328 of the power source 316 and electrically coupled to corresponding terminals of the power source 316. In this regard, the adapter 200 is disposed between the tool 300 and the power source 316.

The receiver(s) 220 can be different shapes and/or sizes, and placed on or in multiple planes of the adapter housing 230. For example, the receiver(s) 220 can be implemented in or on the one or more sides, top, and/or bottom of the adapter housing 230, and can be internal or external to the adapter housing 230. Placing the receivers 220 in or on various portions of the adapter housing 230 in various orientations allows for one or more of the receivers 220 to receive energy from an electromagnetic or magnetic field without requiring the adapter 200 to be placed in a specific orientation relative to the electromagnetic or magnetic field.

Referring back to FIG. 5, each of the receiver(s) 220 may be electrically coupled to the AC/DC converter 222. The energy received or generated by the receiver(s) 220 may be output to the AC/DC converter 222, which converts the energy into an electrical current that can be used to supply power to the power source 316 coupled to the adapter 200 and/or directly to a motor and/or other electrical components of the tool 300.

For example, the AC/DC converter 222 may be coupled to the motor and/or other electrical components of the tool 300, and supply voltage to the motor and/or other electrical components of the tool 200 via the terminals of the tool 300. The AC/DC converter 222 may be electrically coupled to the charging circuit 224, and the charging circuit 224 may be electrically coupled to the power source 316 (such as a rechargeable battery pack) via the terminals of the power source 316. Thus, the AC/DC converter 222 can supply voltage to the power source 316 to charge the power source 316. Instead of a direct coupling, the AC/DC converter 222 may be coupled to the power source 316, motor and/or other electrical components of the tool 300 via one or more batteries and/or capacitors. The batteries and/or capacitors may be used to store voltage until the stored voltage can be used by the tool 300 and/or power source 316.

The communication unit 226 may be adapted to communicate with a transmitter that provides the electromagnetic or magnetic field, and/or other components of the tool 300 and/or power source 316. The communication unit 226 can be used to identify the adapter 200 with the transmitter, state of charge of the power source 316, type of power source 316, and other information useful in optimizing the wireless transfer of energy. For example, if the communication unit 216 informs the transmitter that the power source 316 is substantially full, then the transmitter does not provide any electromagnetic or magnetic field, since charging is unnecessary. Likewise, if the communication unit 216 informs the transmitter that the power source is substantially depleted, the transmitter may create an enhanced electromagnetic or magnetic field to speed charging, and then reduce the electromagnetic or magnetic field once charging is almost complete. It will be appreciated that such communication can be used to create a “smart system,” which is adaptable and modifiable based on, for example, the type of tool, state of charge, and/or type of power source.

Further, one or more of the AC/DC converter 222, charging circuit 224, and communication unit 226 could be housed in the tool 300 and/or the power source 316. In this implementation, the adapter 200 may include connection points or terminals that electrically couple to corresponding connection points or terminals of the tool 300 and/or the power source 316.

Electronic components similar to the electronic components 206 may alternatively or additionally be placed in or on a housing of the power source 316 to allow for independent wireless charging of the power source 316. Further, while the adapter 200 is described as being implemented in connection with a cordless drill type tool, the adapter 200 can be implemented in connection with any type of power tool, including but not limited to, drills, cordless ratchets, cordless torque tools, impact drivers, grinders, saws, hammer drills, flashlights, etc.

In another embodiment, the present invention relates broadly to a structure that emits a magnetic field or an electromagnetic wave or field to wirelessly transmit energy to one or more receivers. In an example, the structure can be a quasi-enclosure that directs the emitted energy. For example, the structure may be a powered transmitter with coils for producing a magnetic field to wirelessly charge tools. When a tool, adapter, and/or battery pack with a receiver is placed in the structure, energy received by the receiver is converted, via power electronics internal or external to the tool, adapter, and/or battery pack, into an electrical current that can be used to supply power to the tool, adapter, and/or battery pack.

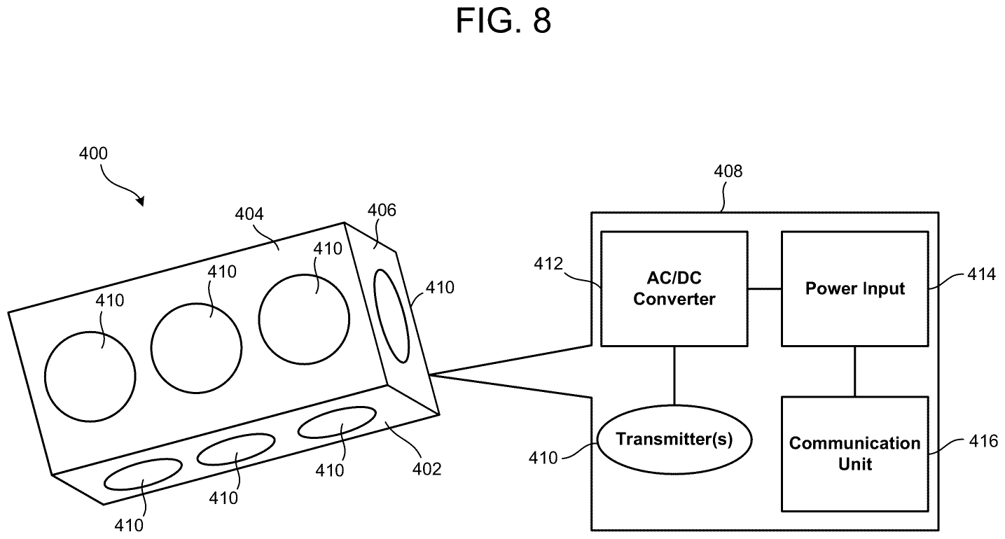

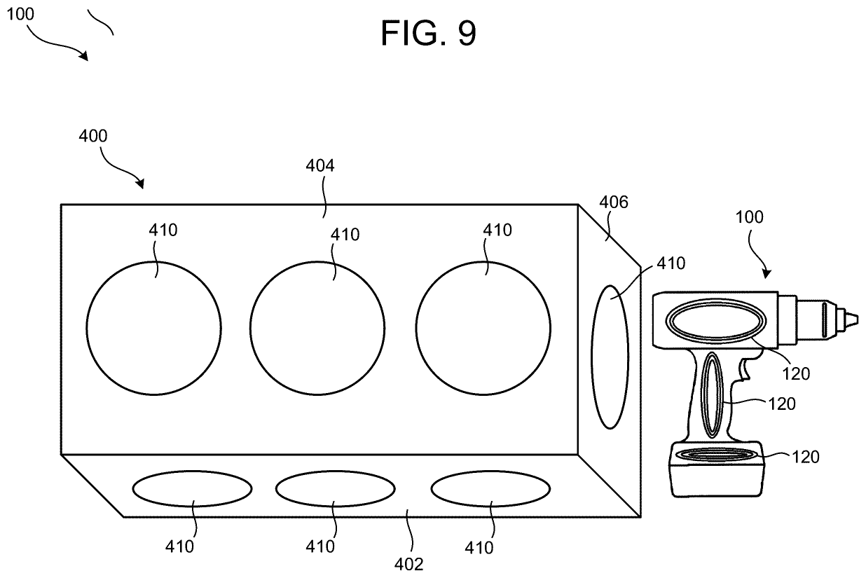

Referring to FIGS. 8 and 9, a transmitting structure 400 is adapted to emit a magnetic field or an electromagnetic wave or field to wirelessly transmit energy to one or more receivers is described. The transmitting structure 400 may include one or more sidewalls that form a quasi-enclosure to direct emitted energy to wirelessly transfer power to receivers of tools, adapters, and/or battery packs of the tools (such as the receivers 120, 220 described above). In embodiments, the transmitting structure 400 produces a magnetic field radiating in at least one plane, but preferably multiple planes.

As shown in FIGS. 8 and 9, the transmitting structure 400 includes a bottom sidewall 402, and first and second sidewalls 404, 406 extending substantially perpendicularly from the bottom side wall 402 and being oriented substantially perpendicularly relative to each other. However, the transmitting structure 400 may have more or less sidewalls, and the sidewalls may be oriented at perpendicular or non-perpendicular angles relative to each other. Further, as illustrated in FIGS. 8 and 9, the sidewalls 402-406 are planar. However, the sidewalls 402-406 may be non-planar, bowed, and/or featured with projections and/or undulations. For example, the transmitting structure 400 can have a single self-supporting wall, such as a single bowed wall.

The transmitting structure 400 also includes electronic components 408. The electronic components 408 may include one or more transmitters 410, an AC/DC converter 412, a power input 414 (such as a plug that can be connected to an external power source), and a communications unit 416. One or more of the transmitters 410 may be disposed, either internally or externally, on each of the sidewalls (such as sidewalls 402, 404, and 406).

In an embodiment, each transmitter 410 may be a coil of wire or other conductive material, that when current flows therethrough, a magnetic field is induced that radiates outwardly away from and about the coil. In another embodiment, each transmitter 410 may be an antennae that transmits or emits electromagnetic energy, in a radio frequency or microwave frequency spectrum. In the case of an antennae, the emitted field may be directional to focus the radiated energy outwardly from the sidewall 402, 404, and/or 406. Each sidewall 402, 404, and/or 406 may also include multiple transmitters 410. In another embodiment, the transmitter 410 may be both a coil shaped and sized to emit a magnetic field and an antennae adapted to emit an electromagnetic signal.

As illustrated in FIGS. 8 and 9, each of the sidewalls 402 and 404 may include three transmitters 410, and the sidewall 406 may include one transmitter 410. However, any one or more of the sidewalls 402, 404, and 406 may include any number of transmitters 410 of varying shapes and/or sizes.

As illustrated, since the sidewalls 402, 404, and 406 (and by extension the corresponding transmitters 410 in the respective sidewalls 402, 404, and 406) are oriented in different planes, the transmitting structure generates a multi-dimensional magnetic field and/or electromagnetic field/wave. This solves the problem of having to specifically orient a device to be charged, because the receiver vectors the wireless energy with negligible loss of efficiency.

The transmitters 410 are electrically coupled to the AC/DC convertor 412, which is electrically coupled to the power input 414 and the communication unit 416. The power input may be a corded plug that electrically couples to an external power source, such as a wall outlet, generator, or battery bank. The AC/DC convertor 412 and communication unit 416 may be housed within one or more of the sidewalls 402, 404, 406, may be disposed in a protrusion on the transmitting structure 400, or may be in a separate module that supplies power to the transmitting structure 400 via a cable or cord.

The communication unit 416 may be adapted to communicate with a receiver, adapter 200, and/or other components of a tool and/or power source (such as a battery pack). The communication unit 416 can be used to identify a tool, adapter, state of charge, and/or type battery pack, with the transmitter, state of charge of the battery pack, and other information useful in optimizing the wireless transfer of energy. For example, if the communication unit 416 informs the transmitter that the power source is substantially full, then the transmitter does not provide any electromagnetic or magnetic field, since charging is unnecessary. Likewise, if the communication unit 416 informs the transmitter that the power source is substantially depleted, the transmitter may create an enhanced electromagnetic or magnetic field to speed charging, and then reduce the electromagnetic or magnetic field once charging is almost complete. It will be appreciated that such communication can be used to create a “smart system,” which is adaptable and modifiable based on, for example, the type of tool, state of charge, and/or type of power source.

Power received by the power input 414 from the external power source is passed to the AC/DC convertor 412, and then to the transmitters 410 to cause the transmitters 410 emit energy. The emitted energy (magnetic field or electromagnetic wave or field) interacts with a receiver (such as the receivers 120, 220 described above), and the receiver responds to the magnetic field or electromagnetic field/wave by producing an electric current in a well-known manner. Since the transmitting structure 400 includes multiple transmitters 410 located in different planes, the magnetic field produced by the transmitting structure 400 is in multiple dimensions and the receiver does not need to be specifically oriented relative to the transmitter to efficiently receive wirelessly transmitted energy. Where the field lines pass through the receiver on the same plane, current is induced into the receiver.

For example, referring to FIG. 9, the tool 100 may be placed in proximity of the transmitting structure 400. The receiver(s) 120 of the tool 100 capture energy via the multidimensional magnetic field produced by the transmitters 410 of the transmitting structure 400. The energy captured by the receiver(s) 120 can then, in addition to powering a motor and other electronics in a tool 100, charge the power source 116, capacitor, or other structures known to those in the art for storing electrical energy that is coupled to the tool 100.

In an embodiment, the transmitting structure 400 forms a quasi-enclosure to help guide a user to place the receiving device in an optimal generalized zone. In other words, the bounds of the transmitting structure 400 create an impression of a bounded space. When a tool, battery pack, or other device with the appropriate receiver is placed within this space, the receiver provides power.

In another embodiment, the present invention relates broadly to a wireless system that wirelessly provides power using resonant wireless power transfer. The wireless system includes one or more transmitting structures capable of providing energy to multiple receiving structures, such as receivers of a tool, battery/battery pack, and/or adapter. The transmitting structure(s) and receiving structure(s) operate at matching resonant frequencies, determined by distributed capacitance, resistance, and/or inductance of the coils of the transmitting structure(s) and receiving structure(s) by tunneling energy from a transmitter (such as a transmitter coil) of the transmitting structure to a receiver (such as a receiver coil) of the receiving structure. In an example, a transmitting structure may transmit a magnetic field in a frequency of about 6.78 MHz or about 13.56 MHz, and is disposed in a desired location to create a magnetic field. When a tool and/or battery/battery pack with the receiver is within the magnetic field, a sensing circuit adapted to detect a magnetic field in a frequency of about 6.78 MHz or about 13.56 MHz and that is connected to the receiver recognizes the magnetic field and signals a control circuit to capture energy, via the magnetic field. The energy received by the receiver can then be converted into an electrical current that can be used to supply power to the tool and/or battery pack.

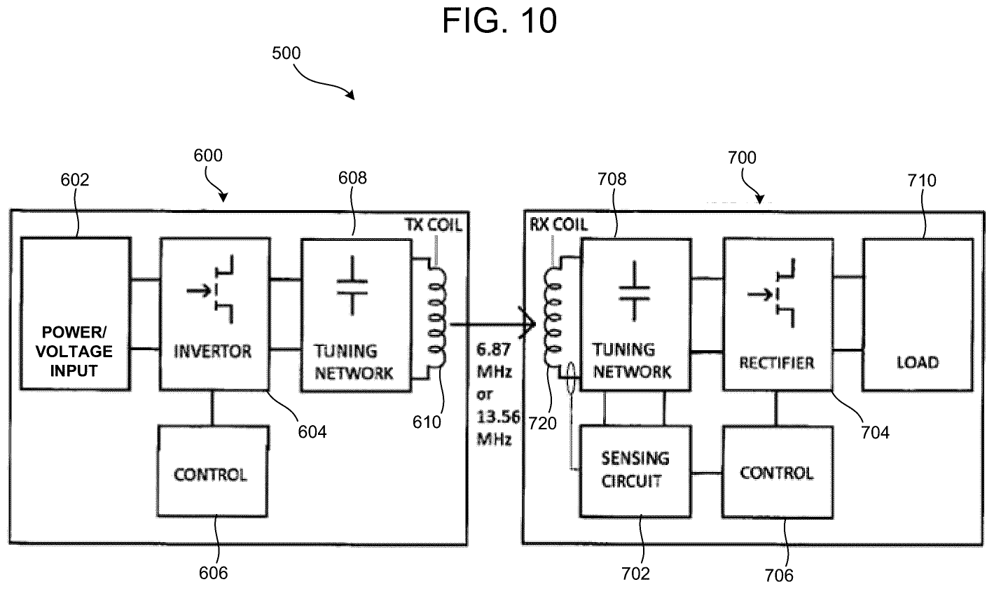

Referring to FIG. 10, a wireless system 500 includes one or more transmitting structures 600 adapted to provide energy to one or more receiving structures 700. A transmitting structure 600 may include a power/voltage input 602 (such as a corded plug) adapted to received power/voltage from an external power source, such as a wall outlet, generator, or battery bank. The transmitting structure 600 also includes an inverter 604, control circuit 606, and a transmitter tuning network 608 operably coupled to one or more transmitters 610 (such as transmitter coils/antennae) to generate a magnetic field in a specified range of 6.87 MHz or 13.56 MHz, for example. For example, power received via the power input 602 may be converted by the invertor 604. The control circuit 606 may then be used to activate the transmitter tuning network 608 to cause the transmitter(s) 610 to generate the magnetic field.

The transmitter 610 may be a coil of wire or other conductive material, that when current flows therethrough, a magnetic field is induced that radiates outwardly away from and about the coil. In another embodiment, each transmitter 610 may be an antennae that transmits or emits electromagnetic energy, in a radio frequency or microwave frequency spectrum. In another embodiment, the transmitter 610 may be both a coil shaped and sized to emit a magnetic field and an antennae adapted to emit an electromagnetic signal.

The transmitting structure 600 may be implemented in a similar manner and in all ways described in connection with the transmitting structure 400, and include one or more sidewalls (with one or more transmitters) that form a quasi-enclosure to produce a magnetic field radiating in at least one plane, preferably multiple planes, at least two planes and more preferably three planes.

A receiving structure 700 may include one or more receivers 720 (such as receiver coils/antennae) operably coupled to a receiver tuning network 708, control circuit 706, sensing circuit 702, voltage convertor 704, and a load circuit 710. The load circuit 710 may be operably coupled to a motor or other components of a tool, a light of a flashlight, an energy storage device (such as a battery pack, capacitor, or other energy storage device), or an adapter.

When the receiver 720 is placed within the magnetic field generated by the transmitting structure 600/transmitter(s) 610, the sensing circuit 702 coupled to the receiver 720 recognizes the magnetic field and signals the control circuit 706 to activate the receiver tuning network 708 to capture the energy. The rectifier or voltage convertor 704 converts the energy to a voltage that can be applied via the load circuit 710.

The receiver(s) 720 can be a coil of wire or other conductive material which, when placed in a magnetic field where the field lines pass through a plane or planes formed by the coil, induce an electric current in the coil. The receiver(s) 720 can alternatively be an antennae adapted to capture electromagnetic energy in a radio frequency or microwave frequency spectrum. In another embodiment, the receiver(s) 720 can be both a coil shaped and sized to interact with a magnetic field and an antennae to interact with an electromagnetic signal.

The receiving structure 700 may be implemented in a similar manner as described above with respect to the tool 100 and adapter 200. For example, the electronic components 106 of the tool 100 can be replaced by the receiving structure 700, and the tool 100 can include receivers 720 in or on various portions of the tool housing 102 in various orientations allows for one or more of the receivers 720 to receive energy from an electromagnetic or magnetic field without requiring the tool 100 to be placed in a specific orientation relative to the electromagnetic or magnetic field. Further, it will be appreciated that the receiving structure 700 can be implemented in any type of power tool, including but not limited to, drills, cordless ratchets, cordless torque tools, impact drivers, grinders, saws, hammer drills, flashlights, etc.

Similarly, the electronic components 206 of the adapter 200 can be replaced by the receiving structure 700, and the adapter 200 can include one or more receivers 720 in or on various portions of the adapter housing 202 in various orientations allows for one or more of the receivers 720 to receive energy from an electromagnetic or magnetic field without requiring the adapter 200 to be placed in a specific orientation relative to the electromagnetic or magnetic field.

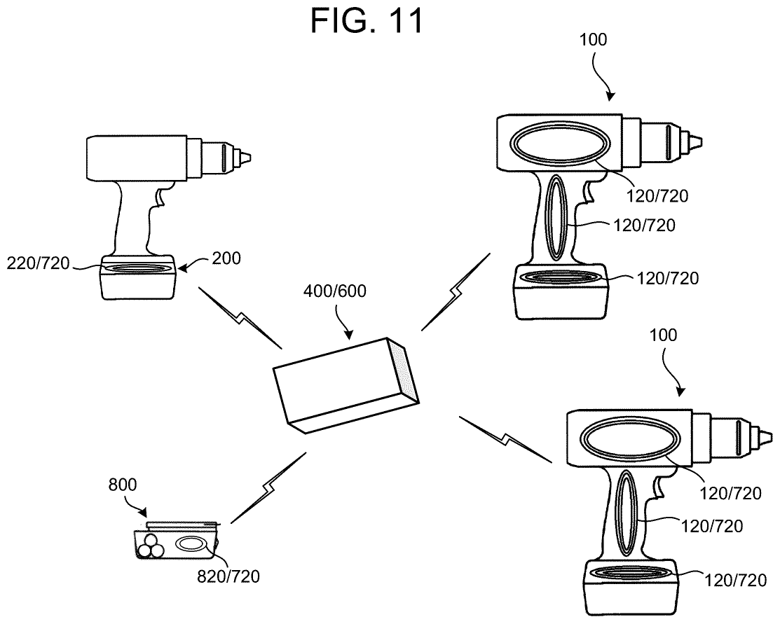

The electronic components 106 or receiving structure 700 may also be implemented in a rechargeable battery pack (such as battery pack 800 shown in FIG. 11) in a similar manner as described above with respect to the tool 100 and adapter 200. For example, one or more receivers 820 (similar to receivers 220) or one or more receivers 720 may be implemented in the battery pack 800 to allow the battery pack 800 to receive energy from an electromagnetic or magnetic field without requiring the battery pack 800 to be placed in a specific orientation relative to the electromagnetic or magnetic field.

The wireless system 500 does not require that the transmitter(s) 610 and receiver(s) 720 be specifically oriented. This allows for imperfect placement of the receiver(s) 720 relative to the transmitter(s) 610. In an example, the wireless system 500 allows for distances of up to about 55 cm (about 1.80 feet) between the transmitter(s) 610 and receiver(s) 720. This allows for greater spatial freedom and power levels up to 1 kW. The frequency of 6.78 MHz or 13.56 MHz increases the transmitter(s) 610 and receiver(s) 720 quality factor, power density, and weight of the system, compared to the lower kHz ranges. Moreover, less materials, such as copper, can be used in the transmitter(s) 610 and receiver(s) 720 to achieve the same performance at lower ranges or the same amount of cooper to increase a quality factor. The use of solid core wire in the transmitter(s) 610 and receiver(s) 720 is an option when in the MHz ranges, compared to the more expensive Litz wire used in coils used in the kHz ranges. The transmitter(s) 610 and receiver(s) 720 can be placed on multiple planes of the respective structures and have different shapes and sizes since they do not have to be similar size to one another the frequency used allows for smaller receiver(s) 720 (coils). Further, transmitter(s) 610 can charge multiple devices via respective receiver(s) 720 compared to inductive charging methods, which requires one transmitting coil for each device.

Referring to FIG. 11, the transmitting structures 400/600 can be placed in a desired location and can charge or supply power multiple devices simultaneously, such as tools 100, adapters 200 and battery packs 800, via respective receiver(s) 120, 220, 720.

As used herein, the term “coupled” can mean any physical, electrical, magnetic, or other connection, either direct or indirect, between two or more components or parts. The term “coupled” is not limited to a fixed direct coupling between components or parts.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool having a tool housing, a motor disposed in the tool housing, and a rechargeable battery pack, the tool comprising:
first and second receivers disposed in the tool housing and adapted to wirelessly receive energy to supply power to at least one of the motor and the rechargeable battery pack.

2. The tool of claim 1, wherein the first and second receivers are disposed in different planes.

3. The tool of claim 1, wherein the first and second receivers are coils of wire.

4. The tool of claim 1, wherein the first and second receivers are antennae.

5. The tool of claim 1, wherein the first and second receivers are antennae and coils of wire.

6. The tool of claim 1, further comprising an AC/DC converter electrically coupled to an output of each of the first and second receivers.

7. The tool of claim 6, wherein the AC/DC converter converts the energy into an electrical current to supply the power to the at least one of the motor and the rechargeable battery pack.

8. An adapter for a power operated tool, the adapter comprising:
an adapter housing including a tool attachment portion adapted to couple to the tool, and a battery attachment portion adapted to couple to a rechargeable battery pack; and
a receiver disposed in the adapter housing and adapted to wirelessly received energy to supply power to at least one of the tool and the rechargeable battery pack.

9. The adapter of claim 8, wherein the receiver includes first and second receivers that are disposed in different planes.

10. The adapter of claim 8, wherein the receiver is a coil of wire.

11. The adapter of claim 8, wherein the receiver is an antenna.

12. The adapter of claim 8, wherein the receiver is an antenna and a coil of wire.

13. The adapter of claim 8, further comprising an AC/DC converter electrically coupled to an output of the receiver.

14. The adapter of claim 13, wherein the AC/DC converter converts the energy into an electrical current to supply the power to the at least one of the tool and the rechargeable battery pack.

15. A transmitting structure for wirelessly providing energy to a receiver, the transmitting structure comprising:
at least one sidewall; and
transmitters disposed in the at least one sidewall, wherein the transmitters are respectively oriented in different planes and are adapted to produce a multidimensional magnetic or electromagnetic field radiating outwardly away from the at least one sidewall.

16. The transmitting structure of claim 15, wherein the at least one sidewall includes first and second sidewalls that are oriented substantially perpendicularly with respect to each other.

17. The transmitting structure of claim 16, wherein the transmitters includes at least three transmitters disposed in the first sidewall and at least one transmitter disposed in the second sidewall.

18. A system for wirelessly providing power, the system comprising:
a transmitting structure including transmitters adapted to produce a multidimensional magnetic or electromagnetic field at a frequency; and
a receiving structure including receivers and a voltage converter, wherein the receivers are adapted to receive energy from the multidimensional magnetic or electromagnetic field, and the voltage converter is adapted to convert the energy to a voltage to be applied to at least one of a power tool and a rechargeable battery pack.

19. The system of claim 18, wherein the transmitting structure includes a sidewall, and the transmitters are disposed in the sidewall.

20. The system of claim 18, wherein the receiving structure is disposed in a power tool.

21. The system of claim 18, wherein the frequency is in a range of about 6.87 MHz to about 13.56 MHz.

22. The system of claim 21, further comprising a sensor that is adapted to sense the multidimensional magnetic or electromagnetic field in the frequency range of about 6.87 MHz to about 13.56 MHz to cause the receivers to receive the multidimensional magnetic or electromagnetic field.
